(19) United States
(12) Patent Application Publication
(10) Pub. No.: US 2026/0237918 A1
(43) Pub. Date: Aug. 13, 2026

(54) TERMINAL BLOCK

(71) Applicant: Yazaki Corporation, Tokyo (JP)

(72) Inventors: Michihiro Mori, Shizuoka (JP); Yoshihiro Iwahori, Shizuoka (JP); Toru Suzuki, Shizuoka (JP)

(73) Assignee: Yazaki Corporation, Tokyo (JP)

(21) Appl. No.: 19/444,302

(22) Filed: Jan. 9, 2026

(30) Foreign Application Priority Data
Feb. 12, 2025 (JP) 2025-020525
Oct. 14, 2025 (JP) 2025-172554

(51) Int. Cl. H01R 9/24

(52) U.S. Cl. CPC H01R 9/24

(57) ABSTRACT

A terminal block includes a bus bar, a magnetic body having a hole through which the bus bar is inserted, a cover having a first fixing portion that is fixed to a casing of a device by a fastening member and holding the magnetic body, and a housing having a second fixing portion that is fixed to the casing by a fastening member and a holding portion that holds the bus bar. In a width direction of the cover, an average position of the first fixing portion may be a gravity center position of the magnetic body, and in a width direction of the housing, an average position of the second fixing portion may be a gravity center position of the housing.

### CROSS-REFERENCE TO RELATED APPLICATION(S)

The present application claims priority to and incorporates by reference the entire contents of Japanese Patent Application No. 2025-020525 filed in Japan on February 12, 2025 and Japanese Patent Application No. 2025-172554 filed in Japan on October 14, 2025.

### BACKGROUND OF THE INVENTION

### 1. Field of the Invention

The present invention relates to a terminal block.

### 2. Description of the Related Art

Conventionally, there is a structure having a bus bar and a magnetic body for removing noise. Japanese Patent Application Laid-open No. 2015-230947 discloses a bus bar holding structure in which a first-phase bus bar, a second-phase bus bar, and a third-phase bus bar are surrounded by a magnetic material.

When a terminal block having a housing for holding a bus bar and a magnetic body surrounding the bus bar is assembled to a casing of a device, it is desirable to be able to suppress deterioration of noise removal performance of the magnetic body. For example, it is preferable that swinging of the magnetic body can be suppressed.

### SUMMARY OF THE INVENTION

An object of the present invention is to provide a terminal block capable of suppressing deterioration of noise removal performance of a magnetic body.

A terminal block according to one aspect of the present invention includes a bus bar; a magnetic body having a hole through which the bus bar is inserted; a cover having a first fixing portion that is fixed to a casing of a device by a fastening member and holding the magnetic body; and a housing having a second fixing portion that is fixed to the casing by a fastening member and a holding portion that holds the bus bar.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to a first embodiment;

FIG. 2 is a perspective view of the terminal block according to the first embodiment;

FIG. 3 is an exploded perspective view of the terminal block according to the first embodiment;

FIG. 4 is a perspective view of a magnetic body according to the first embodiment;

FIG. 5 is a perspective view of a magnetic unit according to the first embodiment;

FIG. 6 is a plan view of the magnetic unit according to the first embodiment;

FIG. 7 is a side view of the magnetic unit according to the first embodiment;

FIG. 8 is a perspective view of a housing according to the first embodiment;

FIG. 9 is a plan view of the housing according to the first embodiment;

FIG. 10 is a side view of a bus bar unit according to the first embodiment;

FIG. 11 is a plan view of the terminal block according to the first embodiment;

FIG. 12 is a cross-sectional view of the terminal block according to first embodiment;

FIG. 13 is a cross-sectional view of the terminal block according to first embodiment;

FIG. 14 is a perspective view of a magnetic unit according to a second embodiment;

FIG. 15 is a plan view of a housing according to the second embodiment;

FIG. 16 is a cross-sectional view of a terminal block according to the second embodiment;

FIG. 17 is a bottom view of a terminal block according to a third embodiment; and

FIG. 18 is a partial cross-sectional view of the terminal block according to third embodiment.

### DETAILED DESCRIPTION OF THE PREFERRED EMBODIMENTS

Hereinafter, a terminal block according to embodiments of the present invention will be described in detail with reference to the drawings. Note that the present invention is not limited by the embodiments. In addition, constituent elements in the following embodiments include those that can be easily assumed by those skilled in the art or those that are substantially the same.

### First Embodiment

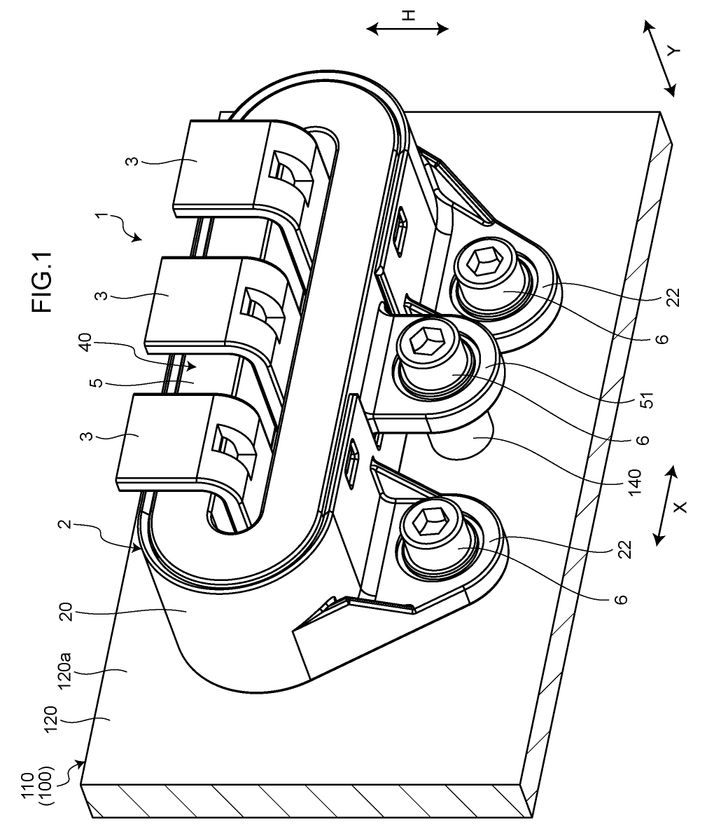

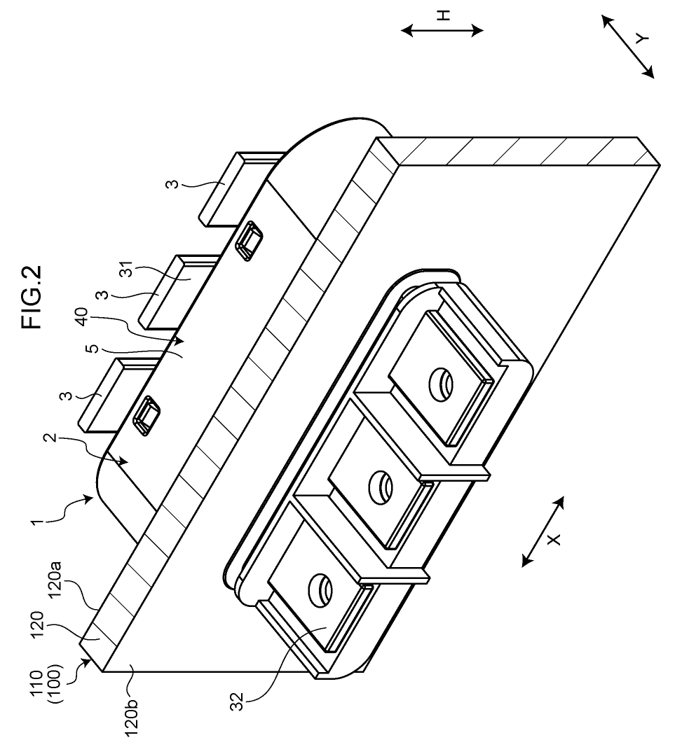

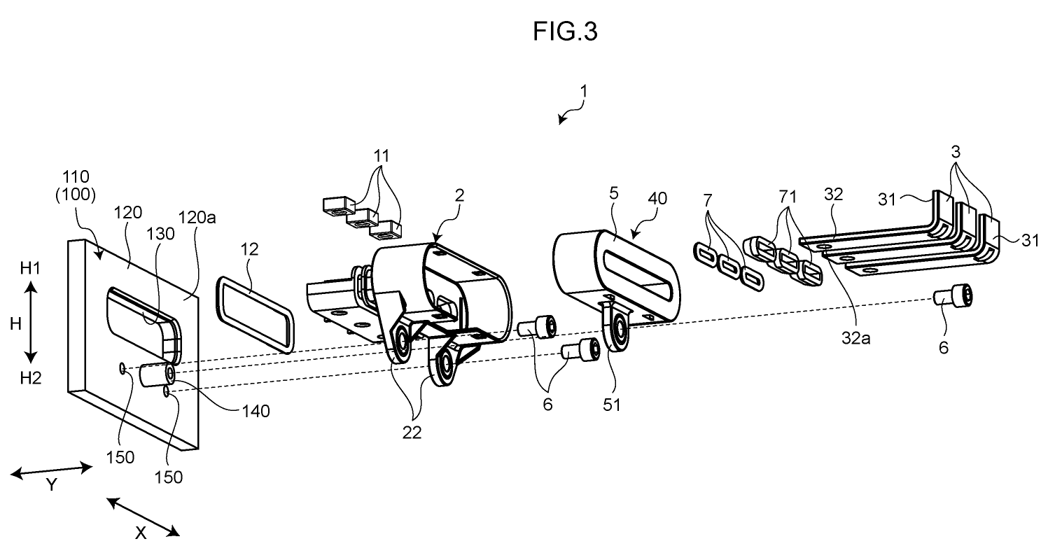

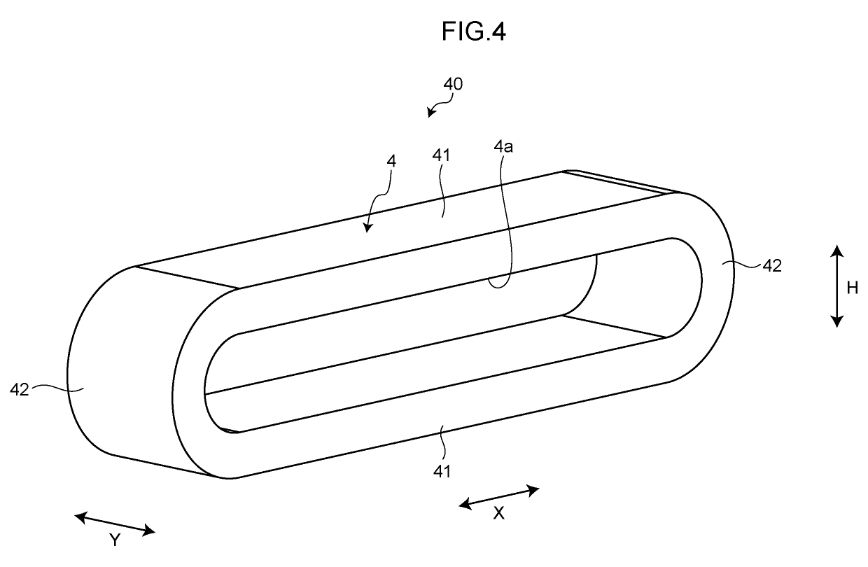

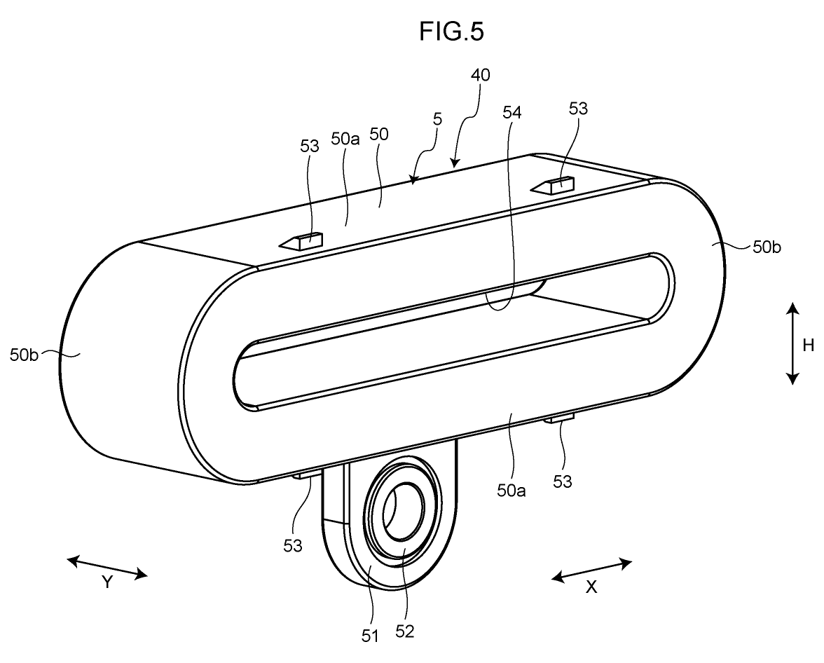

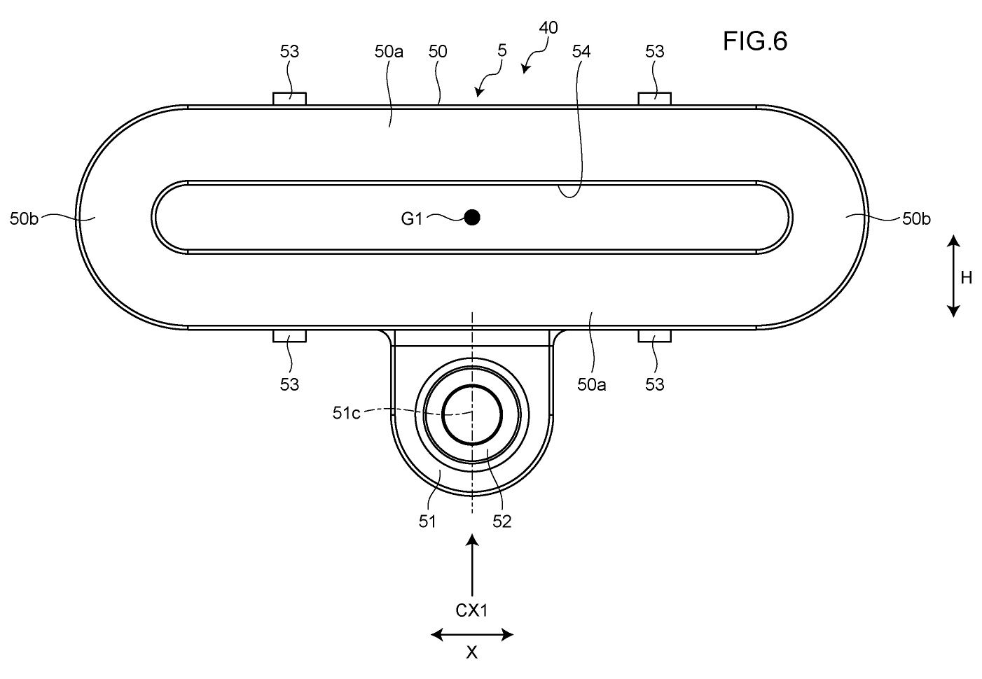

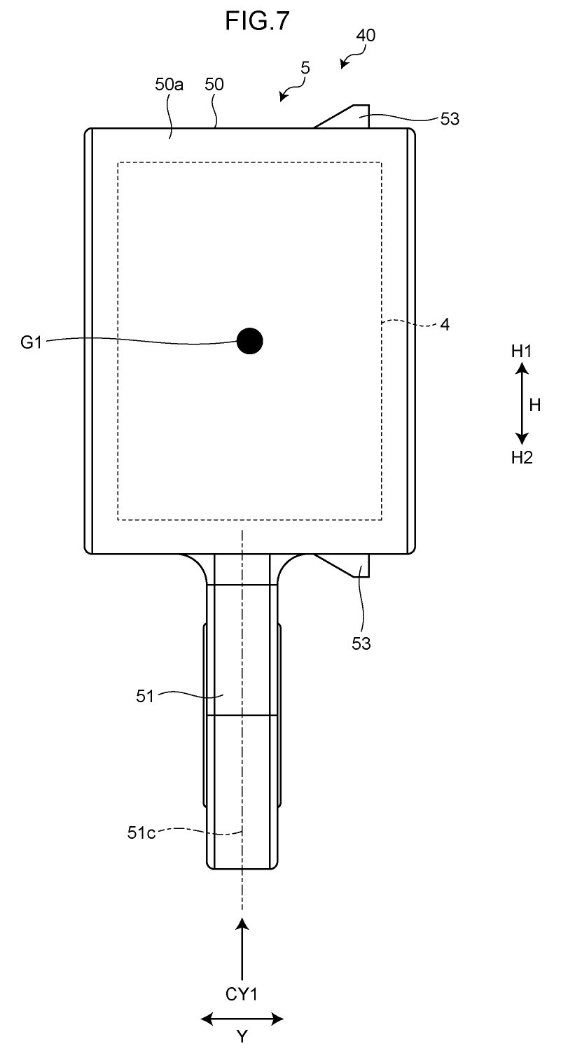

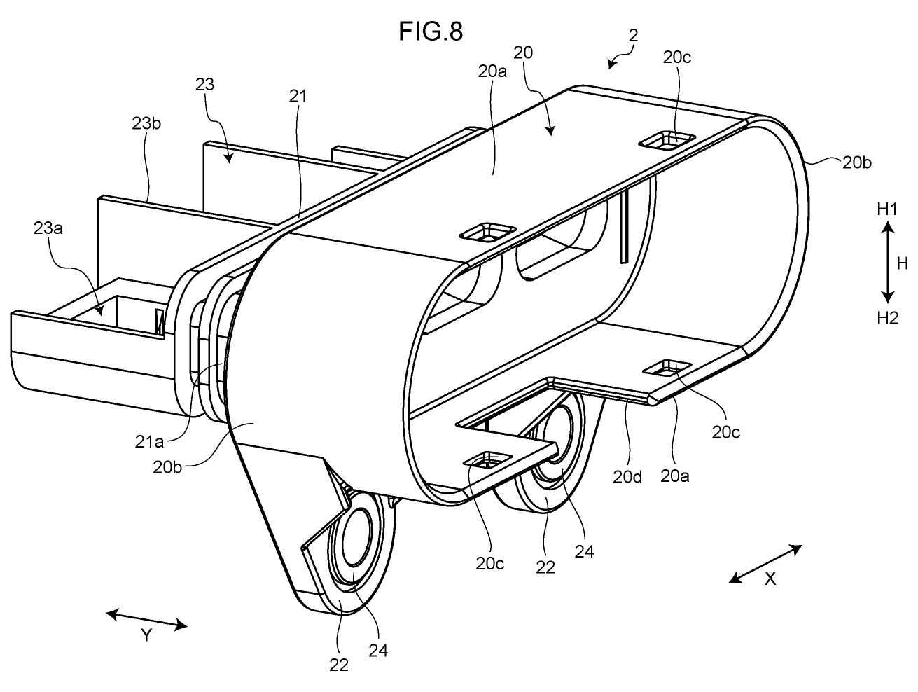

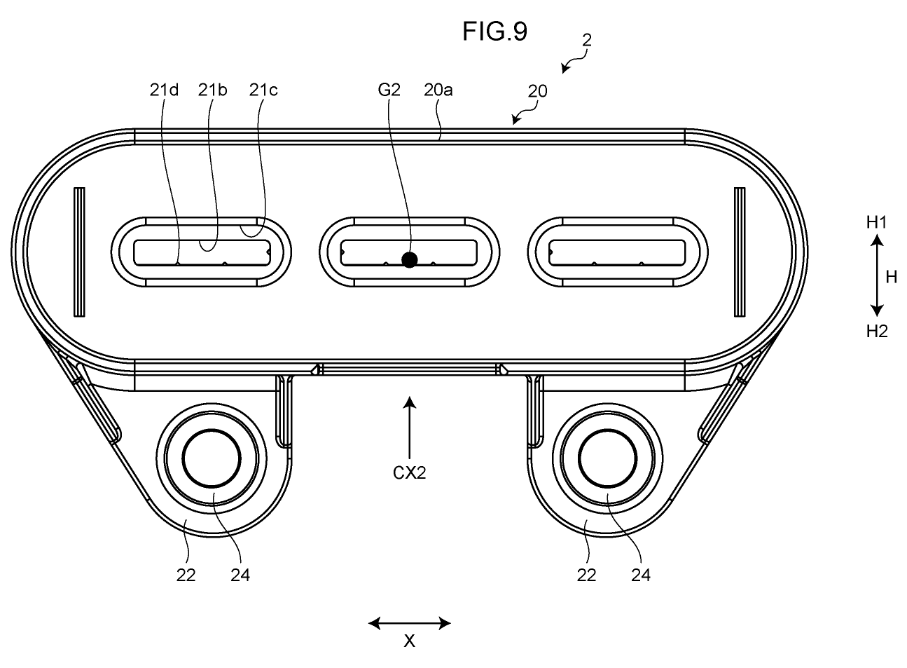

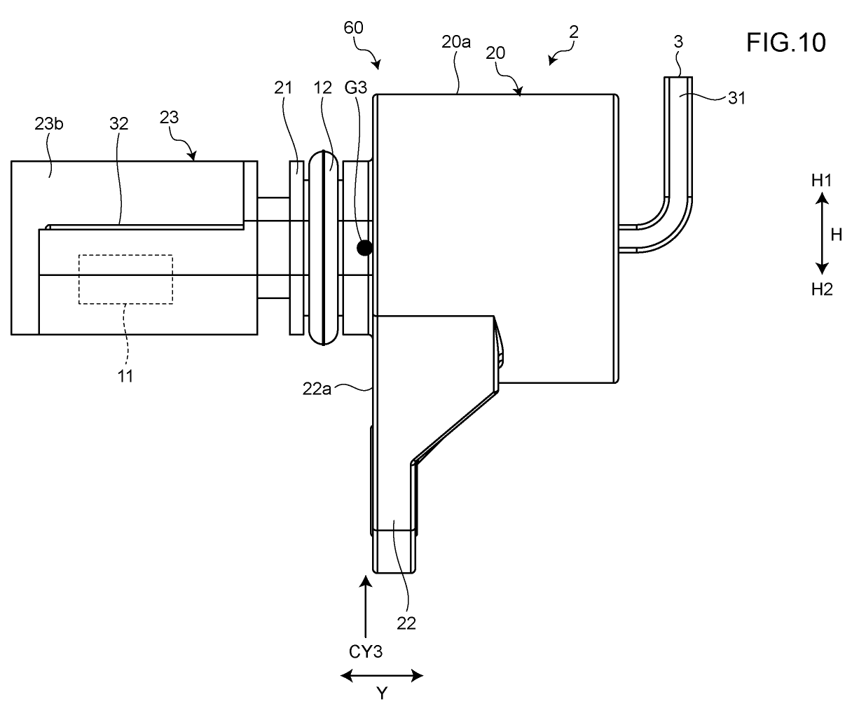

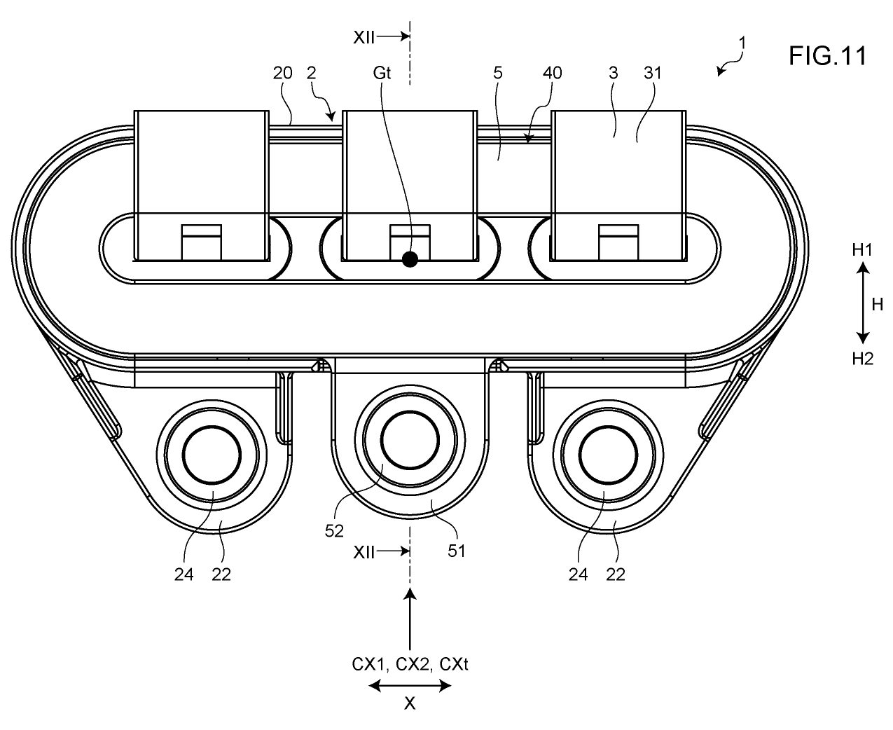

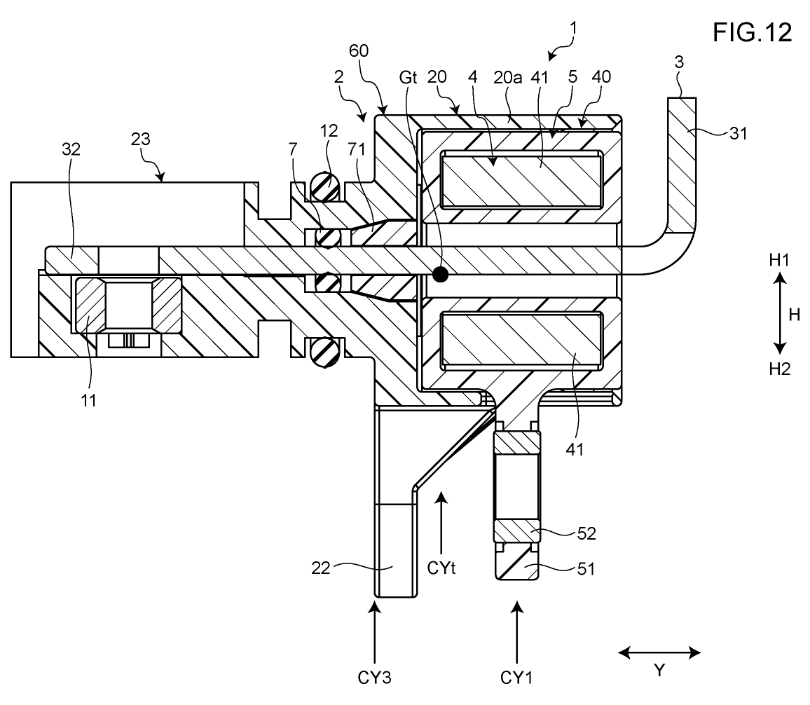

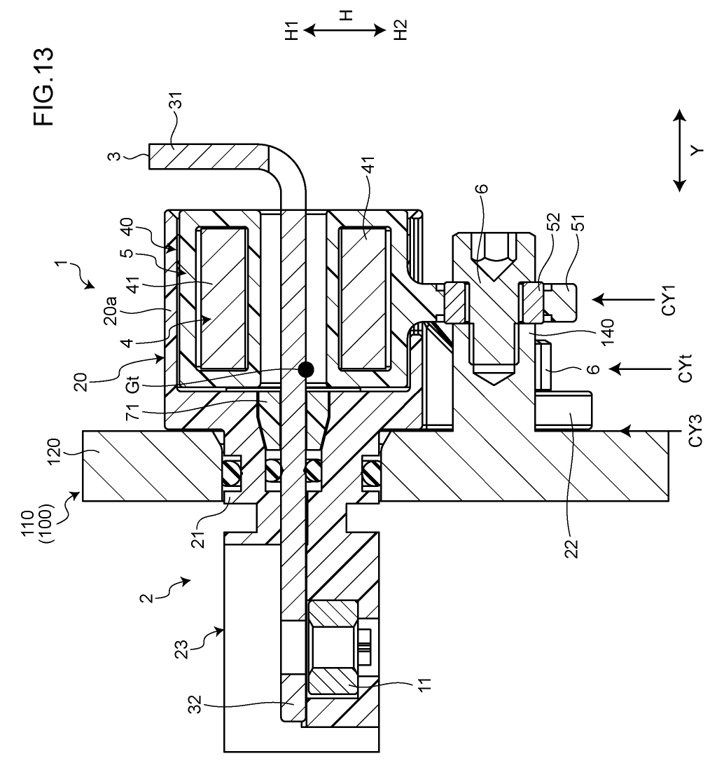

A first embodiment will be described with reference to FIGS. 1 to 13. The present embodiment relates to a terminal block. FIGS. 1 and 2 are perspective views of a terminal block according to a first embodiment, FIG. 3 is an exploded perspective view of the terminal block according to the first embodiment, FIG. 4 is a perspective view of a magnetic body according to the first embodiment, FIG. 5 is a perspective view of a magnetic unit according to the first embodiment, FIG. 6 is a plan view of the magnetic unit according to the first embodiment, FIG. 7 is a side view of the magnetic unit according to the first embodiment, FIG. 8 is a perspective view of a housing according to the first embodiment, FIG. 9 is a plan view of the housing according to the first embodiment, and FIG. 10 is a side view of a bus bar unit according to the first embodiment. FIG. 11 is a plan view of the terminal block according to the first embodiment, and FIGS. 12 and 13 are cross-sectional views of the terminal block according to the first embodiment. FIG. 12 illustrates a cross section taken along line XII-XII in FIG. 11. The cross-sectional position in FIG. 13 is the same as the cross-sectional position in FIG. 12.

As illustrated in FIG. 1, the terminal block 1 of the present embodiment is fixed to a casing 110 of a device 100. The device 100 is, for example, a device mounted on a vehicle such as an automobile. The device 100 may be a motor. The casing 110 of the device 100 has a wall portion 120. The wall portion 120 is, for example, an outer wall of the casing 110. The terminal block 1 is fixed to the wall portion 120 and supported by the wall portion 120. The casing 110 has a width direction X, a depth direction Y, and a height direction H. The width direction X and the depth direction Y are orthogonal to each other. The height direction H is orthogonal to both the width direction X and the depth direction Y. The width direction X and the depth direction Y are, for example, a front-rear direction of the vehicle and a vehicle width direction. In this case, the height direction H is a vehicle vertical direction.

The illustrated wall portion 120 is orthogonal to the depth direction Y. The wall portion 120 has a first wall surface 120a facing the outside of the casing 110 and a second wall surface 120b facing the inside of the casing 110. The first wall surface 120a is a surface in the width direction X and the height direction H, and is, for example, a flat surface. The terminal block 1 is fixed to the casing 110 so as to be in contact with the first wall surface 120a of the wall portion 120.

As illustrated in FIG. 3, the wall portion 120 of the casing 110 is provided with a through hole 130. The through hole 130 is open in each of the first wall surface 120a and the second wall surface 120b. That is, the through hole 130 allows a space portion on one side and a space portion on the other side sandwiching the wall portion 120 to communicate with each other. When the wall portion 120 is the outer wall of the casing 110, the through hole 130 allows an external space and an internal space of the casing 110 to communicate with each other. A housing 2 has a fitting portion 21 that is fitted to the through hole 130.

The wall portion 120 of the casing 110 is provided with a first screw portion 140 and a second screw portion 150. The first screw portion 140 is a female screw portion corresponding to a first fixing portion 51 of a cover 5. The first screw portion 140 protrudes from the first wall surface 120a of the wall portion 120 in the depth direction Y. The illustrated first screw portion 140 has a cylindrical shape, and an inner peripheral surface thereof is provided with a screw thread. The first fixing portion 51 is fixed to a distal end surface of the first screw portion 140 by a fastening member 6.

The second screw portion 150 is a screw portion corresponding to a second fixing portion 22 of the housing 2. The second screw portion 150 is recessed in the depth direction Y from the first wall surface 120a of the wall portion 120. An inner peripheral surface of the second screw portion 150 is provided with a screw thread. The casing 110 of the present embodiment has two second screw portions 150. The two second screw portions 150 are disposed on both sides in the width direction X with the first screw portion 140 interposed therebetween.

As illustrated in FIG. 3, the terminal block 1 has the housing 2, a bus bar 3, a magnetic unit 40, a plurality of fastening members 6, an O-ring 7, a holder 71, a nut 11, and an O-ring 12.

The housing 2 is a member that holds the bus bar 3 and is fixed to the casing 110. The housing 2 is formed using, for example, an insulating synthetic resin. The housing 2 of the present embodiment is fixed to the casing 110 in a state of holding the magnetic unit 40. The nut 11 is a fastening member that fixes the bus bar 3 to a terminal of the device 100, and is housed in a recess of the housing 2. The O-ring 12 is attached to the fitting portion 21 of the housing 2. The O-ring 12 seals a portion between the fitting portion 21 and an inner wall surface of the through hole 130 of the casing 110.

The bus bar 3 is a plate-shaped conductive member, and is formed of a conductive metal plate such as copper. The bus bar 3 has a first terminal portion 31 and a second terminal portion 32. The first terminal portion 31 is one end portion of the bus bar 3, and the second terminal portion 32 is the other end portion of the bus bar 3. The illustrated bus bar 3 is bent at a right angle between the first terminal portion 31 and the second terminal portion 32. A plate-shaped portion of the bus bar 3 having the second terminal portion 32 is inserted through the magnetic unit 40 and the housing 2.

The first terminal portion 31 is connected to a power source side of a battery or the like of the vehicle. The first terminal portion 31 may be connected to an inverter. The second terminal portion 32 is connected to the terminal of the device 100. That is, the bus bar 3 of the present embodiment is interposed between the power supply and the device 100. The illustrated terminal block 1 has three bus bars 3. The second terminal portion 32 is provided with a through hole 32a into which a bolt can be inserted. The second terminal portion 32 is fastened to the terminal of the device 100 by the nut 11 and the bolt.

The O-ring 7 and the holder 71 are members mounted on the bus bar 3. The O-ring 7 seals a portion between the bus bar 3 and a hole of the housing 2. The holder 71 supports the O-ring 7 and regulates positional shift and deformation of the O-ring 7. The bus bar 3 is inserted into the housing 2 with the second terminal portion 32 side as a head in a state where the O-ring 7 and the holder 71 are attached thereto. The holder 71 is disposed on the first terminal portion 31 side with respect to the O-ring 7. The holder 71 supports the O-ring 7 and can push the O-ring 7 to a normal position inside the housing 2.

The magnetic unit 40 has the magnetic body 4 illustrated in FIG. 4 and the cover 5 illustrated in FIG. 5. The magnetic body 4 is formed of a magnetic body having a noise reduction function. The magnetic body 4 is formed of, for example, ferrite. The magnetic body 4 has a hole 4a through which the bus bar 3 can be inserted. The magnetic body 4 of the present embodiment is configured such that the three bus bars 3 can be inserted into one hole 4a. The illustrated magnetic body 4 has a cylindrical shape. More specifically, a cross-sectional shape of the magnetic body 4 in a cross section orthogonal to an axial direction of the hole 4a is an oval shape. In a state where the terminal block 1 is fixed to the casing 110, a major axis direction of the cross section of the magnetic body 4 is the width direction X, and a minor axis direction of the cross section is the height direction H. The axial direction of the hole 4a is the depth direction Y.

The magnetic body 4 has a pair of flat plate portions 41 and a pair of arcuate portions 42. The pair of flat plate portions 41 have a flat plate shape and are parallel to each other. In a state where the terminal block 1 is fixed to the casing 110, the pair of flat plate portions 41 face each other in the height direction H. The arcuate portion 42 has an arcuate shape, and connects an end portion of one flat plate portion 41 and an end portion of the other flat plate portion 41. In a state where the terminal block 1 is fixed to the casing 110, the pair of arcuate portions 42 face each other in the width direction X.

As illustrated in FIG. 5, the cover 5 has a first fixing portion 51 and holds the magnetic body 4. The illustrated cover 5 covers the outer peripheral surface, the inner peripheral surface, and the end surface of the magnetic body 4. The cover 5 is formed of, for example, an insulating synthetic resin. The cover 5 of the present embodiment is molded with respect to the magnetic body 4 and is integrated with the magnetic body 4. Therefore, the magnetic body 4 is sealed inside the cover 5.

The magnetic body 4 may be bonded to the cover 5 or press-fitted into the cover 5. In this case, the cover 5 preferably has a housing chamber that houses the magnetic body 4. For example, the magnetic body 4 is bonded to the cover 5 in a state of being housed in the housing chamber of the cover 5, and is held by the cover 5. For example, the magnetic body 4 is press-fitted into the housing chamber of the cover 5 and held by the cover 5. The cover 5 may have a lid that closes the housing chamber and covers the magnetic body 4.

As illustrated in FIGS. 5 and 6, the cover 5 has a main body 50 that covers the magnetic body 4, a first fixing portion 51, a collar 52, and an engaging portion 53. The main body 50, the first fixing portion 51, and the engaging portion 53 are integrated. The main body 50 has an annular shape and houses the magnetic body 4 therein. The main body 50 has a pair of linear portions 50a and a pair of arcuate portions 50b. The linear portion 50a is a portion covering the flat plate portion 41 of the magnetic body 4 and has a rectangular tube shape. The arcuate portion 50b is a portion covering the arcuate portion 42 of the magnetic body 4 and has a cylindrical shape curved in an arcuate shape. The main body 50 has a hole 54 formed by the pair of linear portions 50a and the pair of arcuate portions 50b. The shape of the hole 54 is an oval shape corresponding to the hole 4a of the magnetic body 4. The bus bar 3 is inserted through the hole 54.

The first fixing portion 51 protrudes from the outer peripheral surface of the main body 50. More specifically, the first fixing portion 51 protrudes from one linear portion 50a of the main body 50. The first fixing portion 51 protrudes toward a side opposite to the side of the other one linear portion 50a. The first fixing portion 51 has a plate shape and holds the collar 52. The collar 52 may be integrated with the first fixing portion 51 by molding, or may be press-fitted into a hole of the first fixing portion 51. The first fixing portion 51 holds the collar 52 such that an axial direction of the collar 52 is the depth direction Y.

As illustrated in FIG. 6, the first fixing portion 51 is disposed in accordance with a gravity center position CX1 of the magnetic body 4. The gravity center position CX1 is a position of a gravity center G1 of the magnetic body 4 in the width direction X. The width direction X is a width direction of the cover 5 and the magnetic body 4, and is a longitudinal direction of the magnetic body 4 in a plan view of the magnetic body 4. In a plan view of the magnetic unit 40, the gravity center G1 of the magnetic body 4 is located on an extension line of a center line 51c of the first fixing portion 51. A center of the collar 52 is located at the same position as the gravity center G1 in the width direction X.

The number of the first fixing portions 51 of the illustrated cover 5 is one. Therefore, an average position of the first fixing portion 51 is a position of one first fixing portion 51. Therefore, in the width direction of the illustrated cover 5, the average position of the first fixing portion 51 coincides with the gravity center position CX1 of the magnetic body 4.

The gravity center position CX1 in the width direction X may be a position of a gravity center of the magnetic unit 40. In the magnetic unit 40 of the present embodiment, the gravity center G1 of the magnetic body 4 and the gravity center of the cover 5 are at the same position in the width direction X. In other words, in the width direction X, the gravity center of the magnetic unit 40 is at the same position as the gravity center G1 of the magnetic body 4 as a single body.

As illustrated in FIG. 7, the first fixing portion 51 is disposed in accordance with a gravity center position CY1 of the magnetic body 4. The gravity center position CY1 is a position of the gravity center G1 of the magnetic body 4 in the depth direction Y. The depth direction Y is the axial direction of the hole 4a of the magnetic body 4, and is an insertion direction of the bus bar 3 with respect to the magnetic body 4. In a side view of the magnetic unit 40, a line of the gravity center position CY1 overlaps the first fixing portion 51. In other words, the position of the first fixing portion 51 in the axial direction of the hole 4a is the gravity center position CY1 of the magnetic body 4. In the side view, the gravity center G1 of the magnetic body 4 may be located on the extension line of the center line 51c of the first fixing portion 51. Note that the gravity center position CY1 in the depth direction Y may be a position of the gravity center of the magnetic unit 40.

The engaging portion 53 protrudes from the outer peripheral surface of the main body 50. More specifically, the engaging portion 53 protrudes from the linear portion 50a of the main body 50. The cover 5 of the present embodiment is provided with four engaging portions 53. Two engaging portions 53 are disposed in each of the pair of linear portions 50a. The two engaging portions 53 are disposed at both ends of the linear portion 50a in the width direction X. The engaging portion 53 disposed at the linear portion 50a on an upper side H1 protrudes toward the upper side H1, and the engaging portion 53 disposed at the linear portion 50a on a lower side H2 protrudes toward the lower side H2.

As illustrated in FIGS. 8 and 9, the housing 2 has a cylindrical portion 20, the fitting portion 21, the second fixing portion 22, a support portion 23, and a collar 24. The cylindrical portion 20, the fitting portion 21, the second fixing portion 22, and the support portion 23 are integrated. The cylindrical portion 20 is a portion that houses the magnetic unit 40 and has a cylindrical shape corresponding to the shape of the magnetic unit 40. The shape of the cylindrical portion 20 in a plan view is an oval shape. The cylindrical portion 20 has a pair of linear portions 20a and a pair of arcuate portions 20b. The linear portion 20a is a portion covering the linear portion 50a of the cover 5 and has a flat plate shape. The arcuate portion 50b is a portion covering the arcuate portion 50b of the cover 5 and has an arcuate plate shape.

As illustrated in FIG. 8, the linear portion 20a of the cylindrical portion 20 is provided with a hole 20c corresponding to the engaging portion 53 of the cover 5. The linear portion 20a on the lower side H2 is provided with a rectangular notch 20d corresponding to the first fixing portion 51 of the cover 5. The notch 20d is disposed at a center of the linear portion 20a on the lower side H2 in the width direction X. Two holes 20c are disposed on both sides in the width direction X with the notch 20d interposed therebetween.

The fitting portion 21 is a portion that is fitted to the through hole 130 of the casing 110. The fitting portion 21 protrudes from the cylindrical portion 20 in the depth direction Y. The shape of the fitting portion 21 is a tubular shape having a substantially rectangular cross-sectional shape or a rectangular parallelepiped shape. An outer peripheral surface of the fitting portion 21 is provided with an annular recess 21a to which the O-ring 12 is mounted.

As illustrated in FIG. 9, the fitting portion 21 is provided with a through hole 21b and a recess 21c. The recess 21c is a housing chamber that houses the O-ring 7, and is open toward an internal space of the cylindrical portion 20. The recess 21c extends in the depth direction Y. The shape of the recess 21c in a plan view of the housing 2 is an oval shape. The through hole 21b is a hole through which the bus bar 3 is inserted, and is open at a bottom portion of the recess 21c. The shape of the through hole 21b in a plan view of the housing 2 is rectangular. The through hole 21b passes through the fitting portion 21 toward the support portion 23.

The fitting portion 21 is provided with through holes 21b and recesses 21c in a number corresponding to the number of bus bars 3. The housing 2 of the present embodiment has three recesses 21c and three through holes 21b arranged in the width direction X. The through hole 21b is a holding portion that holds the bus bar 3 inserted into the through hole 21b. A rib 21d that holds the bus bar 3 is disposed in the through hole 21b.

The support portion 23 is a portion that supports the nut 11. As illustrated in FIG. 8, the support portion 23 protrudes from the fitting portion 21 in the depth direction Y. The support portion 23 has a plurality of recesses 23a and a plurality of partition walls 23b. The recess 23a houses the nut 11 and holds the nut 11. The recess 23a is open toward the upper side H1 in the height direction H. The recess 23a holds the nut 11 such that the central axis of the nut 11 is oriented in the height direction H.

The support portion 23 has the number of recesses 23a corresponding to the number of the bus bars 3. The housing 2 of the present embodiment has three recesses 23a arranged in the width direction X. Each of the three bus bars 3 extends from the through-hole 32b to the support portion 23. The second terminal portion 32 side of the bus bar 3 is provided so as to cover the recess 23a. The second terminal portion 32 side of the bus bar 3 is provided on one side (the upper side H1 in the height direction H) in the axial direction of the nut 11. The partition wall 23b partitions two adjacent recesses 23a. The partition wall 23b extends in the depth direction Y so as to partition the plurality of bus bars 3 protruding from the fitting portion 21.

The second fixing portion 22 protrudes from a boundary portion between the cylindrical portion 20 and the fitting portion 21. The second fixing portion 22 protrudes from one linear portion 20a of the cylindrical portion 20 toward a side opposite to a side of the other linear portion 20a. The second fixing portion 22 has a plate shape and holds the collar 24. The collar 24 may be integrated with the second fixing portion 22 by molding, or may be press-fitted into a hole of the second fixing portion 22. The second fixing portion 22 holds the collar 24 such that an axial direction of the collar 24 is the depth direction Y.

As illustrated in FIG. 9, the second fixing portion 22 is disposed in accordance with a gravity center position CX2 of the housing 2. The gravity center position CX2 is a position of a gravity center G2 of the housing 2 in the width direction X. The width direction X is a width direction X of the housing 2 and is a major axis direction in the cross section of the cylindrical portion 20. In other words, the width direction X is an arrangement direction of the plurality of bus bars 3 held by the housing 2. The housing 2 of the present embodiment has two second fixing portions 22 disposed at both ends in the width direction X. The two second fixing portions 22 are disposed line-symmetrically with respect to a straight line in the height direction H passing through the gravity center position CX2. That is, an average position of the two second fixing portions 22 in the width direction X is the gravity center position CX2 of the housing 2.

In addition, two collars 24 are disposed line-symmetrically with respect to the straight line in the height direction H passing through the gravity center position CX2. That is, an average position of the two collars 24 in the width direction X is the gravity center position CX2 of the housing 2. Centers of the two collars 24 are equidistant from the gravity center position CX2 in the width direction X. Further, the positions of the two collars 24 in the height direction H are the same.

The three through holes 21b and the three recesses 21c are disposed line-symmetrically with respect to the straight line in the height direction H passing through the gravity center position CX2. Therefore, the gravity center position CX2 in the width direction X does not change before and after the three bus bars 3 are assembled to the housing 2. That is, a gravity center G3 of a bus bar unit 60 which will be described later is at the same position as the gravity center G2 of the housing 2 in the width direction X.

FIG. 10 illustrates the housing 2 holding the bus bar 3. In the following description, a unit configured by the housing 2 and the bus bar 3 assembled to the housing 2 is referred to as the bus bar unit 60. The bus bar unit 60 may include the nut 11. The bus bar unit 60 has the gravity center G3. The second fixing portion 22 is disposed in accordance with a gravity center position CY3 of the bus bar unit 60. The gravity center position CY3 is a position of the gravity center G3 of the bus bar unit 60 in the depth direction Y.

In a side view of the bus bar unit 60, the gravity center position CY3 is located at a boundary between the cylindrical portion 20 and the fitting portion 21. The gravity center position CY3 is located on an abutting surface 22a of the housing 2 or in the vicinity of the abutting surface 22a. The abutting surface 22a is a surface of the housing 2 that abuts on the casing 110, and is a plane extending from the cylindrical portion 20 to the second fixing portion 22. Therefore, the bus bar unit 60 can be brought into surface contact with the casing 110 at the position of the gravity center G3.

FIG. 11 illustrates the terminal block 1 configured by assembling the bus bar 3 and the magnetic unit 40 to the housing 2. In a step of assembling the terminal block 1, the bus bar 3 is inserted through the magnetic unit 40, and the holder 71 and the O-ring 7 are attached to the bus bar 3. Thereafter, the second terminal portion 32 of the bus bar 3 is inserted into the housing 2, and the magnetic unit 40 is inserted into the cylindrical portion 20 of the housing 2. The bus bar 3 is held by the through hole 21b of the housing 2. The engaging portion 53 of the magnetic unit 40 is engaged with the hole 20c of the housing 2 and is locked by the hole 20c. That is, in the terminal block 1 illustrated in FIG. 11, the housing 2 houses the magnetic unit 40 in the cylindrical portion 20 and holds the bus bar 3 by the through hole 21b. The housing 2 is configured such that the fitting portion 21 can be fitted to the through hole 130 in this state.

The terminal block 1 of FIG. 11 has a gravity center Gt. The first fixing portion 51 and the second fixing portion 22 are disposed in accordance with a gravity center position CXt of the terminal block 1. The gravity center position CXt is a position of the gravity center Gt of the terminal block 1 in the width direction X.

In the width direction X, the gravity center position CXt of the terminal block 1, the gravity center position CX1 of the magnetic unit 40, and the gravity center position CX2 of the housing 2 are at the same position. The gravity center position of the bus bar unit 60 including the bus bar 3 is also at the same position as the gravity center position CXt of the terminal block 1.

FIG. 12 illustrates a gravity center position CYt of the terminal block 1 in the depth direction Y. The gravity center position CYt is a position of the gravity center Gt of the terminal block 1 in the depth direction Y. In the depth direction Y, the gravity center position CYt is located between the gravity center position CY1 of the magnetic unit 40 and the gravity center position CY3 of the bus bar unit 60. The first fixing portion 51 and the second fixing portion 22 are located on different sides in the depth direction Y with respect to the gravity center position CYt. Therefore, the terminal block 1 is fixed to the casing 110 on both sides in the depth direction Y with respect to the gravity center position CYt.

As illustrated in FIG. 11, in the terminal block 1, the first fixing portion 51 and the two second fixing portions 22 are arranged in the width direction X. The first fixing portion 51 and the second fixing portion 22 are located on the same side in the height direction H with respect to the cylindrical portion 20. In the terminal block 1 of the present embodiment, the first terminal portion 31 of the bus bar 3 extends from the cylindrical portion 20 toward the upper side H1, and the fixing portions 51 and 22 are disposed on the lower side H2 with respect to the cylindrical portion 20. With this arrangement, in a step of fastening the fastening member 6, the bus bar 3 is less likely to interfere with the fastening work. A gap in the width direction X is provided between the first fixing portion 51 at the center and the second fixing portions 22 at both ends. The size of the gap is determined such that the fixing portions 51 and 22 are less likely to interfere with the fastening member 6 in the fastening work.

As illustrated in FIG. 1, the terminal block 1 is fixed to the casing 110 by a plurality of fastening members 6. The illustrated fastening member 6 is a bolt. The first fixing portion 51 of the magnetic unit 40 is fixed to the first screw portion 140 of the casing 110 by the fastening member 6. The second fixing portion 22 of the housing 2 is fixed to the first wall surface 120a of the casing 110 by the fastening member 6. The fastening member 6 that fixes the second fixing portion 22 is screwed into the second screw portion 150 of the casing 110.

In the terminal block 1 of the present embodiment, the cover 5 of the magnetic unit 40 is directly fixed to the casing 110 by the fastening member 6. As a result, swinging of the magnetic body 4 is suppressed as compared with a case where the magnetic unit 40 is indirectly fixed to the casing 110 via the housing 2. By fixing the first fixing portion 51 to the casing 110, swinging of the magnetic body 4 is regulated in each of the width direction X, the height direction H, and the depth direction Y. Therefore, according to the terminal block 1 of the present embodiment, the noise removal performance of the magnetic body 4 is less likely to fluctuate and the noise removal performance is less likely to deteriorate.

In addition, since the magnetic unit 40 and the housing 2 are fixed to the casing 110, positional shift and swinging of the magnetic body 4 with respect to the bus bar 3 are suppressed. Therefore, according to the terminal block 1 of the present embodiment, the noise removal performance by the magnetic body 4 is less likely to fluctuate and the noise removal performance is less likely to deteriorate.

Furthermore, since the magnetic unit 40 is directly fixed to the casing 110, the weight applied to the housing 2 is reduced as compared with a case where the magnetic unit 40 is supported by the casing 110 via the housing 2. Therefore, vibration of the housing 2 is suppressed. Therefore, quality improvement including noise removal in the terminal block 1 is realized.

### Second Embodiment

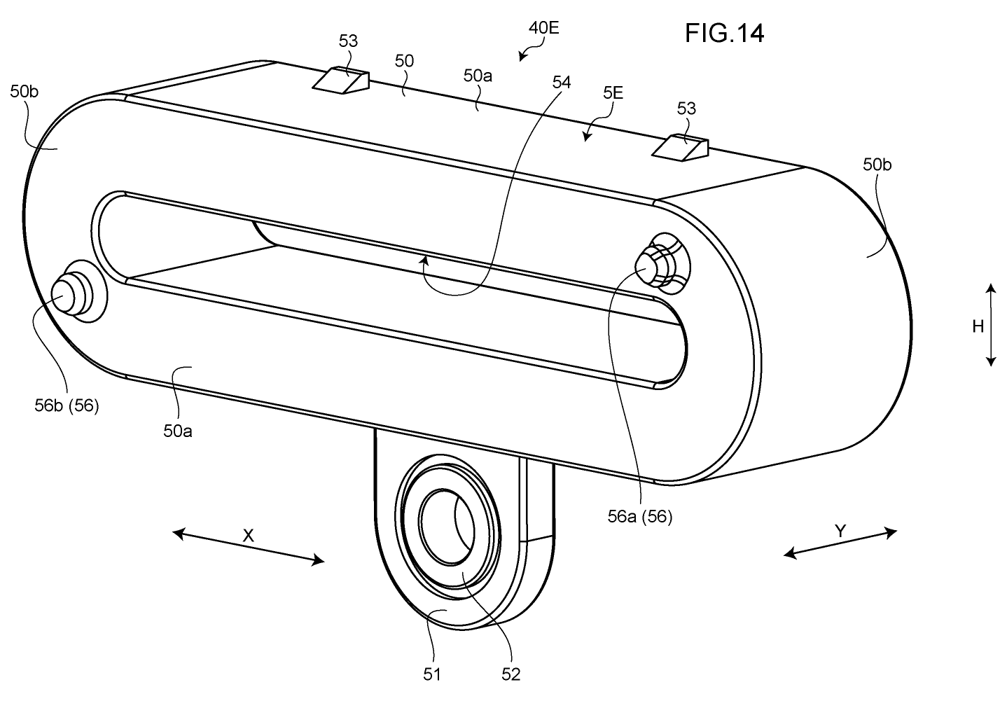

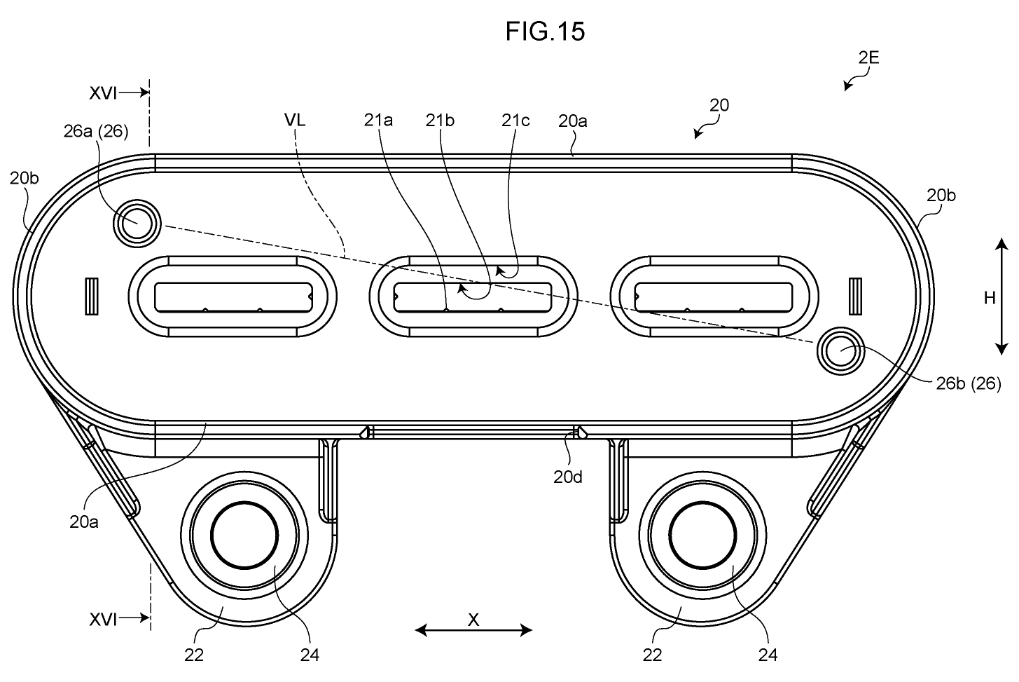

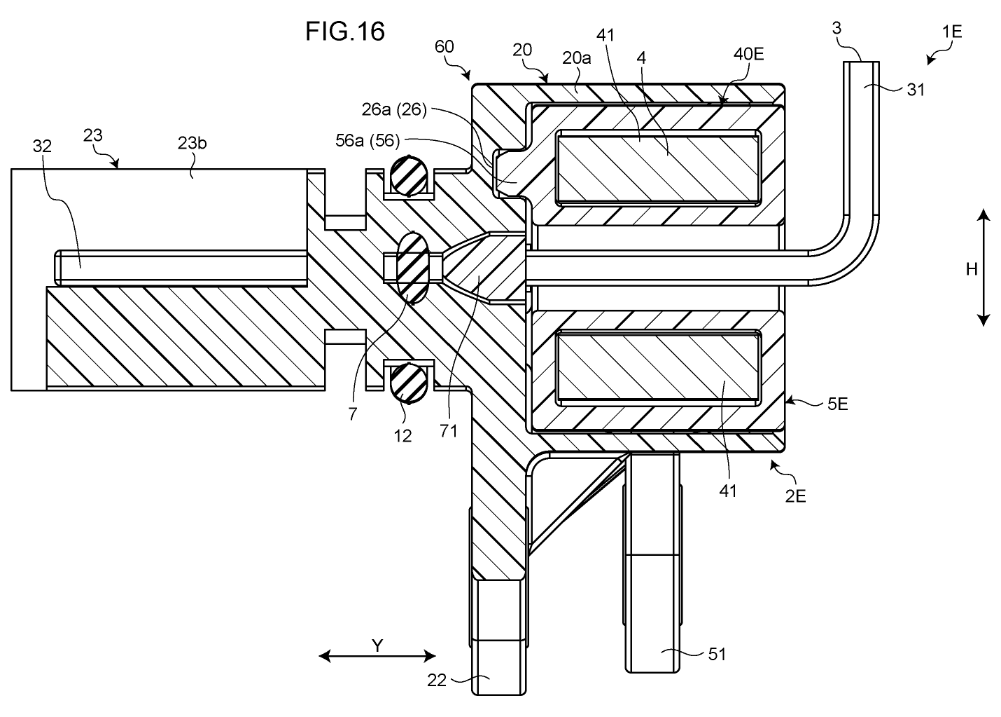

A second embodiment will be described with reference to FIGS. 14 to 16. In a terminal block 1E according to the present embodiment, a housing 2E having a pin hole portion 26 is employed instead of the housing 2 of the first embodiment, and a cover 5E having a pin 56 is employed instead of the cover 5. The same members, the same parts, and the like as in the first embodiment are denoted by the same reference numerals, and the description thereof will be omitted or simplified. FIG. 14 is a perspective view of a magnetic unit according to the second embodiment, FIG. 15 is a plan view of a housing according to the second embodiment, and FIG. 16 is a cross-sectional view of a terminal block according to the second embodiment. FIG. 16 illustrates a cross section taken along line XVI-XVI in FIG. 15.

As illustrated in FIG. 14, the pin 56 is provided on one side of the outer peripheral surface of the cover 5E orthogonal to the depth direction Y. Here, the surface on one side of the outer peripheral surface of the cover 5E orthogonal to the depth direction Y is a surface that faces a bottom surface of the cylindrical portion 20 of the housing 2E in which the recess 21c is provided when the magnetic unit 40E is assembled to the housing 2E.

The pin 56 protrudes in the depth direction Y which is a direction in which the bus bar 3 is inserted. On the other hand, the pin hole portion 26 is provided in the bottom surface of the cylindrical portion 20 of the housing 2E orthogonal to and intersecting the depth direction Y. The pin hole portion 26 is formed in a bottomed recess shape that is fitted with the pin 56 in a concavo-convex manner and does not penetrate.

In the present embodiment, two pins 56 and two pin hole portions 26 are provided as pins 56a and 56b and pin hole portions 26a and 26b, respectively. As illustrated in FIG. 15, the two pin hole portions 26a and 26b are provided so as to face each other on an inclined line VL which intersects the axial direction of the hole 4a (the hole 4a of the magnetic body 4, see FIG. 4) through which the bus bar 3 is inserted and is inclined with respect to the width direction X of the housing 2E. In the present embodiment, the pin hole portion 26a is provided on the left side in the width direction X and on the upper side in the height direction H of the cylindrical portion 20 as viewed in FIG. 15. The pin hole portion 26b is provided on the right side in the width direction X and on the lower side in the height direction H of the cylindrical portion 20 as viewed in FIG. 15. Similarly for the pin 56, the two pins 56a and 56b are provided to face each other on the inclined line VL. In other words, the pin 56a is provided on one side of two connecting portions between the linear portions 50a and the arcuate portions 50b of the cover 5E on one side in the width direction X. The pin 56b is provided on the other side of the two connecting portions between the linear portions 50a and the arcuate portions 50b of the cover 5E on the other side in the width direction X. Similarly, the pin hole portion 26a is provided on one side of two connecting portions between the linear portions 20a and the arcuate portions 20b of the cylindrical portion 20 on one side in the width direction X. The pin hole portion 26b is provided on the other side of the two connecting portions between the linear portions 20a and the arcuate portions 20b of the cylindrical portion 20 on the other side in the width direction X.

The pin 56 and the pin hole portion 26 are fitted with each other in a concavo-convex manner as illustrated in FIG. 16. The pin 56a is fitted to the pin hole portion 26a in a concavo-convex manner, and the pin 56b is fitted to the pin hole portion 26b in a concavo-convex manner.

### Third Embodiment

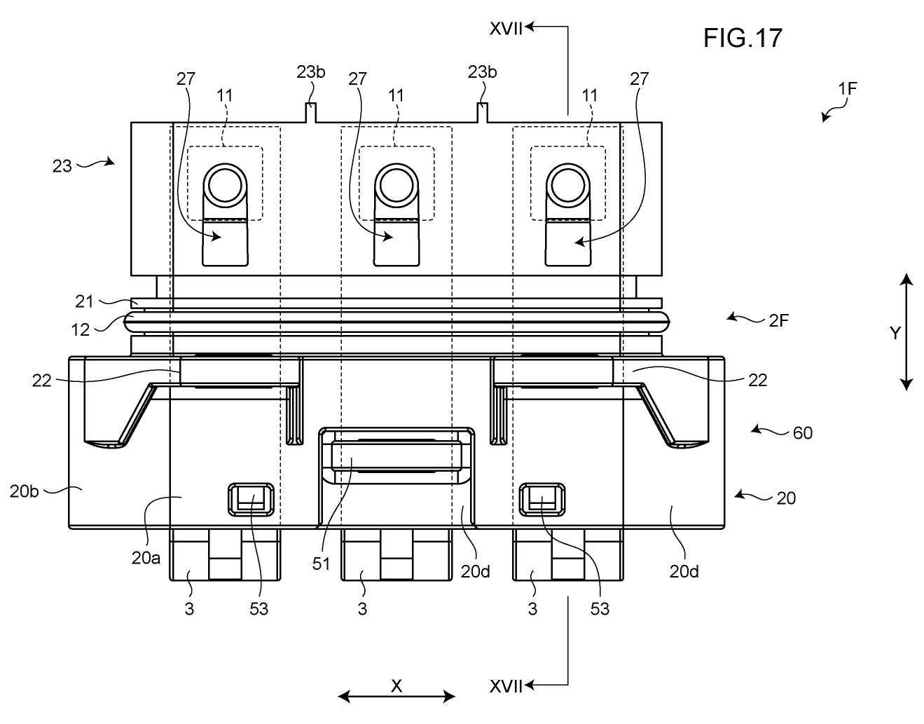

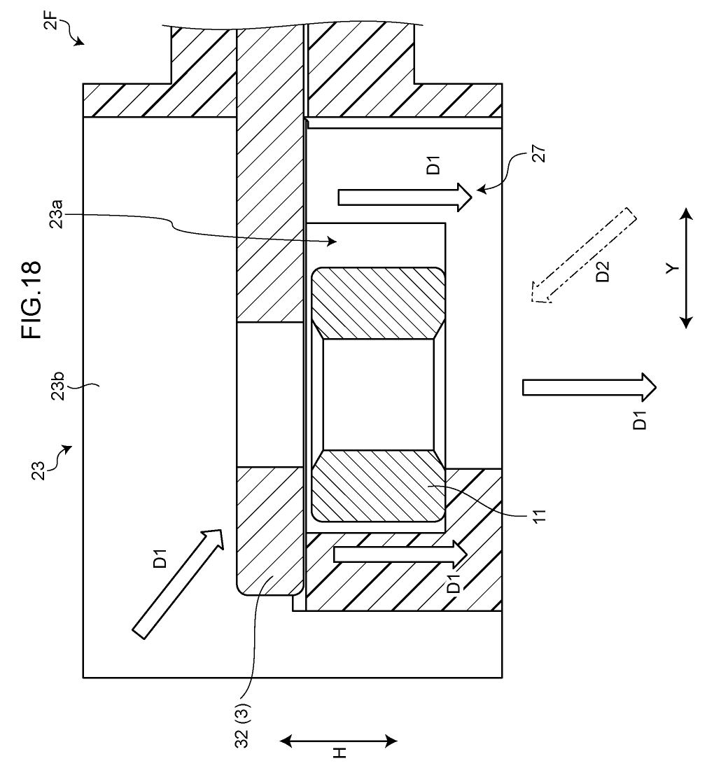

A third embodiment will be described with reference to FIGS. 17 and 18. In a terminal block 1F according to the present embodiment, a housing 2F in which a flow opening 27 is provided in the support portion 23 is employed instead of the housing 2 of the first embodiment. The same members, the same parts, and the like as in the first embodiment are denoted by the same reference numerals, and the description thereof will be omitted or simplified. FIG. 17 is a bottom view of the terminal block 1F. FIG. 18 is an enlarged cross-sectional view enlarging the support portion 23 with respect to a cross section taken along line XVII-XVII in FIG. 17.

As illustrated in FIGS. 17 and 18, the flow opening 27 is provided at a bottom portion of the recess 23a of the support portion 23. In other words, the flow opening 27 is provided on the other side (the lower side H2 in the height direction H) in the axial direction of the nut 11. As in the first embodiment, the bus bar 3 is provided on one side (the upper side H1 in the height direction H) in the axial direction of the nut 11 so as to cover the recess 23a. The flow opening 27 is open to expose the nut 11 and the bus bar 3 to the outside. That is, as illustrated in FIG. 17, the nut 11 and the bus bar 3 can be seen from the flow opening 27. The flow opening 27 is formed in an arc shape along a screw hole of the nut 11 on a distal end side (back side in the depth direction Y in the support portion 23). The flow opening 27 is formed in a substantially long rectangular shape on a proximal end side (fitting portion 21 side).

For example, in the casing 110 of the device 100, cooling oil may flow through the support portion 23 of the terminal block 1F. Here, in FIG. 18, directions D1 and D2 indicate a flowing direction of the oil. As illustrated in FIG. 18, in the support portion 23, when the oil flows from the upper side H1 direction in the height direction H as indicated by the direction D1, the oil passes through a clearance between a periphery of the nut 11 and the recess 23a from a clearance around the bus bar 3 (second terminal portion 32). Then, the oil that has passed through the periphery of the nut 11 is discharged to the outside from the flow opening 27.

Further, as indicated by the direction D2, the cooling oil can be brought into contact with the nut 11 and the bus bar 3 from the lower side H2 (a bottom portion side of the recess 23a) in the height direction H of the support portion 23.

As described above, the terminal block 1, 1E, 1F of the present embodiment has the bus bar 3, the magnetic body 4 having the hole 4a through which the bus bar 3 is inserted, the cover 5, 5E that holds the magnetic body 4, and the housing 2, 2E, 2F. The cover 5, 5E has the first fixing portion 51 that is fixed to the casing 110 of the device 100 by the fastening member 6. The housing 2 has the second fixing portion 22 that is fixed to the casing 110 by the fastening member 6 and the holding portion which holds the bus bar 3. The holding portion of the present embodiment is the through hole 21b provided in the fitting portion 21 of the housing 2. In the terminal block 1 of the present embodiment, the cover 5 holding the magnetic body 4 is directly fixed to the casing 110 by the fastening member 6. Therefore, the terminal block 1 of the present embodiment can suppress variations in noise removal performance and deterioration in noise removal performance of the magnetic body 4.

In the present embodiment, in the width direction X of the cover 5, 5E, the average position of the first fixing portion 51 is the gravity center position CX1 of the magnetic body 4. In the width direction X of the housing 2,2E, 2F, the average position of the second fixing portions 22 is the gravity center position CX2 of the housing 2. Such arrangement of the fixing portions 51 and 22 suppresses swinging of each of the magnetic body 4 and the housing 2.

The housing 2, 2E, 2F of the present embodiment has the cylindrical portion 20 that houses the cover 5, 5E and the magnetic body 4, and the fitting portion 21 that is fitted to the through hole 130 of the casing 110. The housing 2, 2E, 2F is configured such that the fitting portion 21 can be fitted to the through hole 130 in a state where the cover 5, 5E and the magnetic body 4 is housed in the cylindrical portion 20 and the bus bar 3 is held by the holding portion. Therefore, according to the terminal block 1, 1E, 1F of the present embodiment, the workability of the work of assembling the terminal block 1, 1E, 1F to the casing 110 is improved.

In the present embodiment, when the fitting portion 21 is fitted to the through hole 130, the first fixing portion 51 faces the first screw portion 140, and the second fixing portion 22 faces the second screw portion 150. At this time, the first fixing portion 51 is positioned such that the hole of the collar 52 faces the screw hole of the first screw portion 140. The second fixing portion 22 is positioned such that the hole of the collar 24 faces the screw hole of the second screw portion 150. Therefore, the workability of the work of assembling the terminal block 1, 1E, 1F to the casing 110 is improved.

The housing 2, 2E, 2F of the present embodiment is configured to house the cover 5, 5E and the magnetic body 4 in the cylindrical portion 20 such that the gravity center position CX1 of the magnetic body 4 coincides with the gravity center position CX2 of the housing 2 in the width direction X of the housing 2, 2E, 2F. Such a relationship between the gravity center positions CX1 and CX2 is illustrated in FIG. 11, for example. In the width direction X of the housing 2, 2E, 2F, the average position of the second fixing portions 22 is the gravity center position CX2 of the housing 2. With such a configuration, vibration caused by the shift of the gravity center positions CX1 and CX2 is suppressed.

In the terminal block 1, 1E, 1F of the present embodiment, in the width direction X of the housing 2, 2E, 2F, the average position of the first fixing portion 51 and the average position of the second fixing portions 22 are at the same position. As illustrated in FIG. 11, in the width direction X, the gravity center position CX1 of the magnetic body 4 and the gravity center position CX2 of the housing 2, 2E, 2F are at the same position. The average position of the first fixing portion 51 is the gravity center position CX1 of the magnetic body 4, and the average position of the second fixing portions 22 is the gravity center position CX2 of the housing 2. Therefore, in the width direction X of the housing 2 in a state where the magnetic body 4 is assembled to the housing 2, the average position of the first fixing portion 51 and the average position of the second fixing portions 22 are at the same position. With such an arrangement, the posture of the terminal block 1, 1E, 1F is stabilized, and swinging of the respective parts of the terminal block 1, 1E, 1F is suppressed.

In the terminal block 1, 1E, 1F of the present embodiment, the first fixing portion 51 and the second fixing portion 22 are arranged in the width direction X of the housing 2 in a state where the cover 5, 5E and the magnetic body 4 are housed in the cylindrical portion 20. With such a configuration, the first fixing portion 51 and the second fixing portion 22 can be collectively disposed on the same side with respect to the bus bar 3.

In the present embodiment, the position of the first fixing portion 51 in the axial direction of the hole 4a of the magnetic body 4 is the gravity center position CY1 of the magnetic body 4. With such an arrangement, swinging of the magnetic body 4 is effectively regulated.

In the terminal block 1E according to the present embodiment, the housing 2E has the cylindrical portion 20 that houses the cover 5E and the magnetic body 4, the cover 5E has the pin 56 that is one of the pin 56 protruding in the direction in which the bus bar 3 is inserted and the pin hole portion 26 that is fitted with the pin 56 in a concavo-convex manner, and the cylindrical portion 20 has the pin hole portion 26 that is the other of the pin 56 and the pin hole portion 26. As a result, the positional shift of the cover 5E with respect to the cylindrical portion 20 is suppressed. For example, when the cover 5E is shifted with respect to the housing 2E, the position of the collar 52 of the cover 5E may be shifted with respect to the first screw portion 140. Therefore, a relatively large collar 52 may be used. Then, a washer is required for the fastening member 6 screwed into the first screw portion 140. However, according to the terminal block 1E of the present embodiment, the positional shift of the cover 5E with respect to the housing 2E can be suppressed by the fitting of the pin 56 and the pin hole portion 26 with each other in a concavo-convex manner. Therefore, the collar 52 can be made relatively small, and the terminal block 1E can also be made small. In addition, by making the collar 52 relatively small, it is not necessary to secure a wide seat surface of the fastening member 6, and thus, it is not necessary to provide a washer, and it is possible to suppress an increase in the number of parts.

In the present embodiment, the plurality of pins 56a and 56b and the plurality of pin hole portions 26a and 26b are provided so as to face each other on the inclination line VL that intersects the axial direction of the hole 4a and is inclined with respect to the width direction X of the housing 2E. As a result, the movement of the cover 5E in the width direction X and the height direction H including a rotation direction around the axis of the hole 4a with respect to the housing 2E is regulated, so that the positional shift is further suppressed.

In the present embodiment, the housing 2F of the terminal block 1F has the fitting portion 21 that is fitted to the through hole 130 of the casing 110 and the support portion 23 that protrudes from the fitting portion 21 and has the recess 23a in which the nut 11 is housed, the bus bar 3 is provided on one side in the axial direction of the nut 11 so as to cover the recess 23a, the support portion 23 has the flow opening 27 on the other side in the axial direction of the nut 11, and the flow opening 27 is open so as to expose the nut 11 and the bus bar 3 to the outside. As a result, the cooling oil can be efficiently brought into contact with the bus bar 3 and the nut 11. Therefore, the bus bar 3 can be downsized. By circulating the oil around the nut 11, it is possible to reduce heat generation from the bus bar 3 occurring at the time of energization.

The number of bus bars 3 of the terminal block 1 is not limited to three. The number of bus bars 3 may be two or less, or four or more. In the terminal block 1 of the present embodiment, it is easy to expand the number of poles of the bus bar 3.

The number of the first fixing portions 51 provided on the cover 5 is not limited to one. The cover 5 may have a plurality of first fixing portions 51 arranged in the width direction X. The plurality of first fixing portions 51 may be disposed at equal intervals in the width direction X. When the cover 5 has the plurality of first fixing portions 51, it is desirable that the average position of the plurality of first fixing portions 51 in the width direction X is disposed in accordance with the gravity center position CX1.

For example, when the number of the first fixing portions 51 is an even number, the average position in the width direction X is desirably located between the two first fixing portions 51 located in the middle in the arrangement direction. In this case, the average position in the width direction X preferably coincides with the gravity center position CX1.

When the number of the first fixing portions 51 is an odd number, the average position in the width direction X is preferably at the position of one first fixing portion 51 located at the center in the arrangement direction. In this case, the average position in the width direction X preferably coincides with the gravity center position CX1.

In the terminal block 1E, two pins 56 and two pin hole portions 26 are provided, but one or three or more pins 56 and pin hole portions 26 may be provided.

The contents disclosed in the above embodiments can be appropriately combined and executed.

A terminal block according to the present embodiment includes a bus bar, a magnetic body having a hole through which the bus bar is inserted, a cover having a first fixing portion that is fixed to a casing of a device by a fastening member and holding the magnetic body, and a housing having a second fixing portion that is fixed to the casing by a fastening member and a holding portion that holds the bus bar. According to the terminal block of the present embodiment, the cover that holds the magnetic body is directly fixed to the casing, so that it is possible to suppress deterioration of noise removal performance of the magnetic body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar;
a magnetic body having a hole through which the bus bar is inserted;
a cover having a first fixing portion that is fixed to a casing of a device by a fastening member and holding the magnetic body; and
a housing having a second fixing portion that is fixed to the casing by a fastening member and a holding portion that holds the bus bar.

2. The terminal block according to claim 1, wherein
in a width direction of the cover, an average position of the first fixing portion is a gravity center position of the magnetic body, and
in a width direction of the housing, an average position of the second fixing portion is a gravity center position of the housing.

3. The terminal block according to claim 1, wherein
the housing has a cylindrical portion that houses the cover and the magnetic body, and a fitting portion that is fitted to a through hole of the casing, and
the housing is configured such that the fitting portion is able to be fitted to the through hole in a state where the cover and the magnetic body are housed in the cylindrical portion and the bus bar is held by the holding portion.

4. The terminal block according to claim 3, wherein
the housing is configured to house the cover and the magnetic body in the cylindrical portion such that a gravity center position of the magnetic body coincides with a gravity center position of the housing in a width direction of the housing, and
in the width direction of the housing, an average position of the second fixing portion is a gravity center position of the housing.

5. The terminal block according to claim 4, wherein
in the width direction of the housing, an average position of the first fixing portion and the average position of the second fixing portion are at the same position.

6. The terminal block according to claim 3, wherein
the first fixing portion and the second fixing portion are arranged in a width direction of the housing in a state where the cover and the magnetic body are housed in the cylindrical portion.

7. The terminal block according to claim 1, wherein
a position of the first fixing portion in an axial direction of the hole is a gravity center position of the magnetic body.

8. The terminal block according to claim 1, wherein
the housing has a cylindrical portion that houses the cover and the magnetic body,
the cover has one of a pin protruding in a direction in which the bus bar is inserted and a pin hole portion that is fitted with the pin in a concavo-convex manner, and
the cylindrical portion has the other of the pin and the pin hole portion.

9. The terminal block according to claim 8, wherein
a plurality of the pins and the pin hole portions are provided so as to face each other on an inclined line that intersects an axial direction of the hole and is inclined with respect to a width direction of the housing.

10. The terminal block according to claim 1, wherein
the housing has a fitting portion that is fitted to a through hole of the casing, and a support portion that protrudes from the fitting portion and includes a recess in which a nut is housed,
the bus bar is provided on one side in an axial direction of the nut so as to cover the recess,
the support portion has a flow opening on the other side in the axial direction of the nut, and
the flow opening is open so as to expose the nut and the bus bar to the outside.
